(19) United States
(12) Patent Application Publication
(10) Pub. No.: US 2016/0204482 A1
(43) Pub. Date: Jul. 14, 2016

(54) RECHARGEABLE BATTERY

(71) Applicant: SAMSUNG SDI CO., LTD., Yongin-si (KR)

(72) Inventors: Min-Yeol HAN, Yongin-si (KR); Su-Jin YOON, Cheonan-si (KR)

(21) Appl. No.: 14/802,043

(22) Filed: Jul. 17, 2015

(30) Foreign Application Priority Data
Jan. 14, 2015 (KR) 10-2015-0006991

(51) Int. Cl. H01M 10/48; H01M 2/14; H01M 2/04

(52) U.S. Cl. CPC H01M 10/488; H01M 2/0456; H01M 2/14

(57) ABSTRACT

A rechargeable battery, including an electrode assembly including a first electrode and a second electrode; a case having an open side, the electrode assembly housed in the case; a cap assembly having a cap plate to tightly close the open side of the case, a first terminal connected to the first electrode electrically, and a second terminal electrically connected to the second electrode; and at least one membrane mounted to the cap plate between the first terminal and the second terminal.

### CROSS-REFERENCE TO RELATED APPLICATION

Korean Patent Application No. 10-2015-0006991, filed on Jan. 14, 2015, in the Korean Intellectual Property Office, and entitled: “Rechargeable Battery,” is incorporated by reference herein in its entirety.

### BACKGROUND

1. Field

Embodiments relate to a rechargeable battery.

2. Description of the Related Art

Different from a primary battery which may be incapable of recharging, a rechargeable battery is a battery in which charging thereto and discharging therefrom may be possible. A low capacity rechargeable battery may be used for a small portable electronic device, e.g., a mobile phone, a laptop computer, or a camcorder, and a large capacity rechargeable battery may be used as a power source for driving a motor of, for example, a hybrid vehicle.

### SUMMARY

Embodiments may be realized by providing a rechargeable battery, including an electrode assembly including a first electrode and a second electrode; a case having an open side, the electrode assembly housed in the case; a cap assembly having a cap plate to tightly close the open side of the case, a first terminal connected to the first electrode electrically, and a second terminal electrically connected to the second electrode; and at least one membrane mounted to the cap plate between the first terminal and the second terminal.

The at least one membrane may be concave or convex.

The rechargeable battery may include a plurality of membranes. Each of the plurality of membranes may have a different threshold value for causing sequential flipping of the plurality of membranes if an internal pressure of the case rises due to gas generated in the case.

Each of the plurality of membranes may have a different surface area.

Each of the plurality of membranes may have a different thickness.

Each of the plurality of membranes may be formed of an elastic material to have elastic force.

The cap plate and the plurality of membranes may be connected by welding.

### BRIEF DESCRIPTION OF THE DRAWINGS

Features will become apparent to those of skill in the art by describing in detail exemplary embodiments with reference to the attached drawings in which:

FIG. 1 illustrates a perspective view of a rechargeable battery in accordance with an embodiment;

FIG. 2 illustrates a cross-sectional view across a line II-II in FIG. 1;

FIG. 3 illustrates a partial cross-sectional view of operation of a first membrane of the rechargeable battery in FIG. 2;

FIG. 4 illustrates a partial cross-sectional view of operation of a second membrane of the rechargeable battery in FIG. 2; and

FIG. 5 illustrates a partial cross-sectional view of operation of a third membrane of the rechargeable battery in FIG. 2.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Parts not relevant may be omitted for ease of description, and throughout the specification, identical or similar parts will be given the same reference numbers.

Since sizes and thicknesses of elements are shown at will for convenience of description, the thicknesses may be enlarged for clearly expressing different parts and regions.

Throughout the specification, unless explicitly described to the contrary, the word “comprise” and variations such as “comprises” or “comprising” will be understood to imply the inclusion of stated elements but not the exclusion of any other elements.

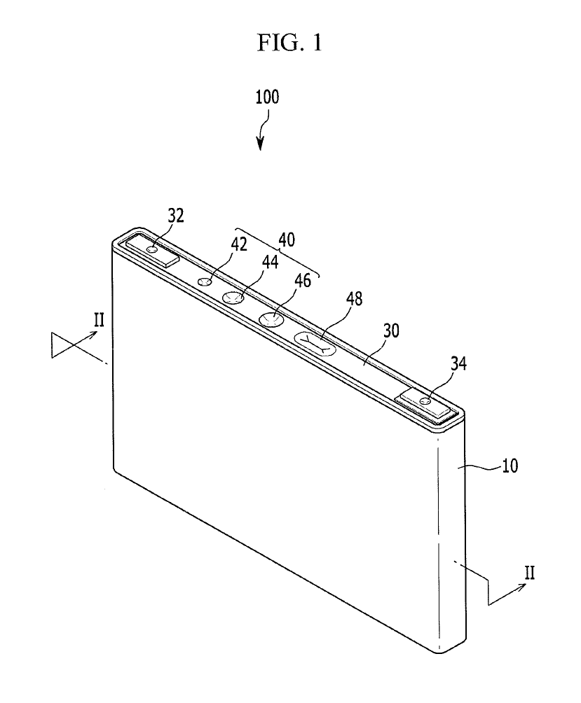

FIG. 1 illustrates a perspective view of a rechargeable battery in accordance with an embodiment.

Referring to FIG. 1, the rechargeable battery 100 may have a case 10 with a cap plate 30 mounted to a top side thereof for tightly closing the case 10, and a first terminal 32 and a second terminal 34 provided on respective sides thereof to construe a cap assembly. There may be a plurality of membranes 40 and a vent 48 mounted to the cap plate 30 between the first terminal 32 and the second terminal 34.

The membrane 40 of the rechargeable battery 100 in accordance with an embodiment may have, for example, a circular plan view. If the membrane 40 is circular, since the membrane 40 may be connected to the cap plate 30 without a corner, the membrane 40 may maintain a fixed threshold value to a gas pressure generated in the rechargeable battery 100. In an embodiment, the membrane may have a square or polygonal shape.

The membrane 40 may be positioned between the first terminal 32 and the second terminal 34. In an embodiment, the membrane 40 may be positioned on a side of the first terminal 32 and the second terminal 34. The membrane 40 may be positioned between the first terminal 32 and the second terminal 34 for easy determination of a reaction of the membrane 40 to the pressure of gas generated in the rechargeable battery 100 from outside of the rechargeable battery 100 by the naked eye.

The membrane 40 may be concave in the case 10 if the pressure in the rechargeable battery 100 is normal. The term “concave” refers to a central circular depression similar to a concavity with a curvature.

A plurality of membranes 40 may be mounted to the cap plate 30. For example, the membrane 40 may include a first membrane 42, a second membrane 44, and a third membrane 46, distances therebetween and surfaces areas thereof mounted to the cap plate 30 may vary with a pressure range the user may intend to measure, and the distances may not be equal without fail. The first, second, and third membranes 42, 44, and 46 may have threshold values that are set different from one another to make the membranes flip in response to an increase of the internal pressure of the rechargeable battery 100.

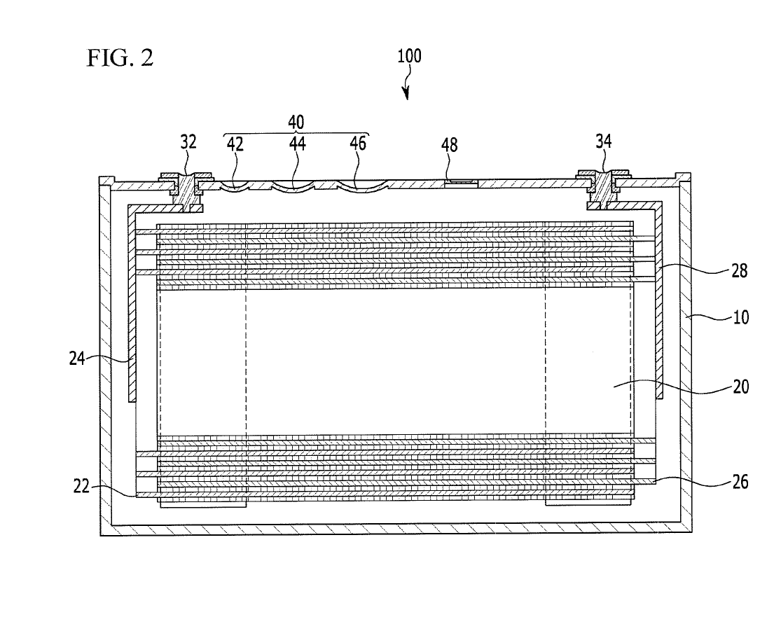

FIG. 2 illustrates a cross-sectional view across a line II-II in FIG. 1.

Referring to FIG. 2, the electrode assembly 20 of the rechargeable battery 100 in accordance with an embodiment may be placed in the case 10 in a shape of a jelly-roll, e.g., the electrode assembly 20 may be housed in the case 10. For example, referring to FIG. 2, if the electrode assembly 20 is placed in the case 10 in a shape of a jelly-roll, uncoated regions 22 and 26 of the first and second electrodes may be arranged in a lateral direction. The first electrode uncoated region 22 may project, e.g., protrude, to a left side, and a first connection member 24 may extend along the left side of the case to be placed at and connected to the first electrode uncoated regions 22, and to be connected to the first terminal 32 at the top side of the case 10. The second electrode uncoated region 26 may project e.g., protrude, to the right side, and a second connection member 28 may extend along a left side of the case 10 to be placed at and connected to the second electrode uncoated regions 26, and to be connected to the second terminal 34 at the top side of the case 10. The first terminal 32 and the second terminal 34 may be arranged on respective sides of the case.

The membrane 40 may be arranged between the first terminal 32 and the second terminal 34 such that the membrane 40 does not interfere with the first and second connection members 24 and 28, the membrane 40 responds to a change of the pressure caused by gas generated in an abnormal state in the rechargeable battery 100, and easily notifies the user thereof.

The membrane 40 may be concave starting from a plane flush with the top side of the cap plate 30, to not form a step thereon.

The membrane 40 may be connected to the cap plate 30 by welding. After making a hole in the cap plate 30 to have the same size as the membrane 40, the membrane 40 may be connected to the cap plate 30 by welding.

The first, second, and third membranes 42, 44, and 46 may have different surface areas from one another, the pressures respectively applied to the membranes 42, 44, and 46 may be different, and pressure threshold values of the membranes 40 corresponding to an increase of the internal pressure may be different.

The first, second, and third membranes 42, 44, and 46 may have different thicknesses from one another, and differences of pressure threshold values corresponding to increase of the internal pressure of the membrane 40.

Different from the vent 48, the membrane 40 may not discharge gas generated in the case 10 of the rechargeable battery 100.

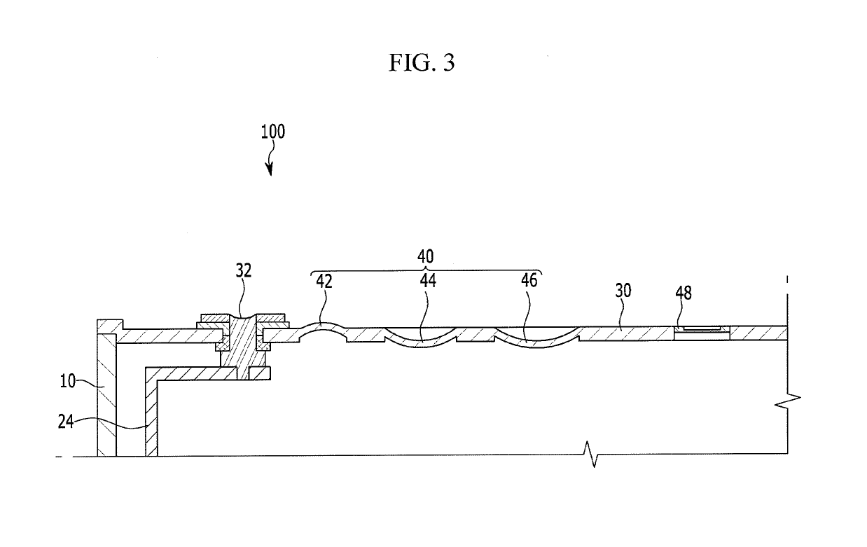

FIG. 3 illustrates a partial cross-sectional view of operation of a first membrane of the rechargeable battery in FIG. 2.

Referring to FIG. 3, gas generated in the rechargeable battery 100 may accumulate in the case 10 to make the internal pressure increase, and the membrane 40 may flip in response to the increase of the pressure. Since the rechargeable battery 100 may have the internal pressure increased for the first time, there may not be a difficulty in normal charging and discharging of the rechargeable battery 100. The first membrane 42 may maintain an original state, i.e., the concave state, up to a preset internal pressure threshold value, until a moment the internal pressure exceeds the threshold value of the first membrane 42 when the first membrane 42 may flip outward to an outside of the case 10. For example, the first membrane 42 may be in a convex state with respect to the outside of the case 10.

The membrane 40 may be formed of an elastic material to be elastic. The membrane 40 may flip or return to the original state according to an increase or decrease of the internal pressure.

If the first membrane 42 flips to curve outward to be convex with respect to the outside of the case 10, the internal volume of the case 10 may increase, and the internal pressure of the rechargeable battery 100 may decrease. Since the rechargeable battery 100 may have the internal pressure decreased to lower than a case, e.g., a situation or instance, when the first membrane had no reaction, the rechargeable battery 100 may charge and discharge more securely.

Upon looking at a flipped state of the first membrane 42, i.e., the first membrane 42 is flipped to curve outward to be convex with respect to the outside of the case 10, the user may notice that the rechargeable battery 100 has gas generated therein, and the internal pressure of the rechargeable battery 100 may become high due to the gas generated therein.

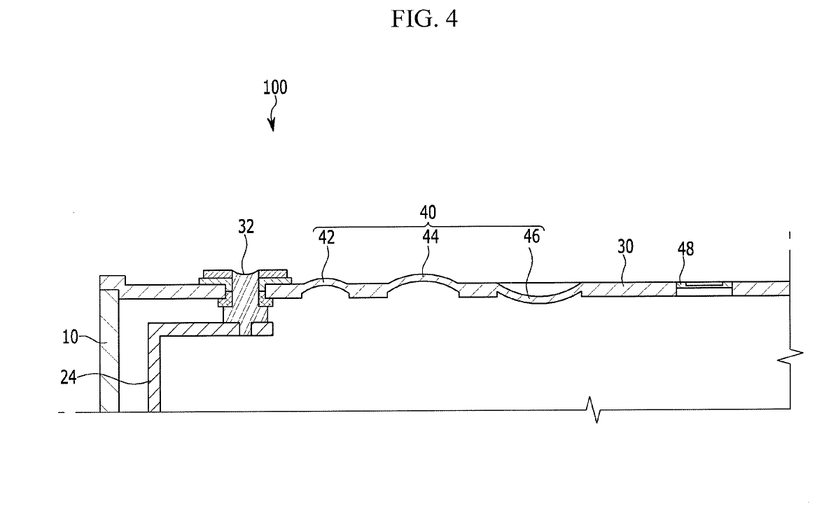

FIG. 4 illustrates a partial cross-sectional view of an operation of a second membrane of the rechargeable battery in FIG. 2.

FIG. 4 illustrates a state in which the second membrane 44 is flipped, i.e., curved outward to be convex with respect to the outside of the case 10. A user may understand that the internal pressure of the rechargeable battery 100 is higher than the internal pressure in the case, e.g., the situation or instance, of the first membrane 42 set by a manufacturer, and that the higher pressure is being maintained in the rechargeable battery 100.

After notifying the user of the internal pressure state of the case 10 with the flip of the first membrane 42, which may be caused by an increase of the internal pressure of gas accumulated in the case 10 of the rechargeable battery 100 generated as the electrolyte is decomposed by the heat generated in the rechargeable battery 100, a volume of the case 10 of the rechargeable battery 100 may increase by as much as, e.g., a volume equal to, displacement of the flip of the first membrane 42, making the charging and discharging of the rechargeable battery 100 secure. Even thereafter, if gas is still generated, the second membrane 44 may be flipped from the concave state to the outside of the case 10 to curve outward to be convex with respect to the outside of the case 10, notifying the user of the present internal pressure state of the rechargeable battery 100 for the second time. Then, the rechargeable battery 100 may have the internal pressure reduced to lower than when the second membrane 44 does not react, enabling more secure charging and discharging.

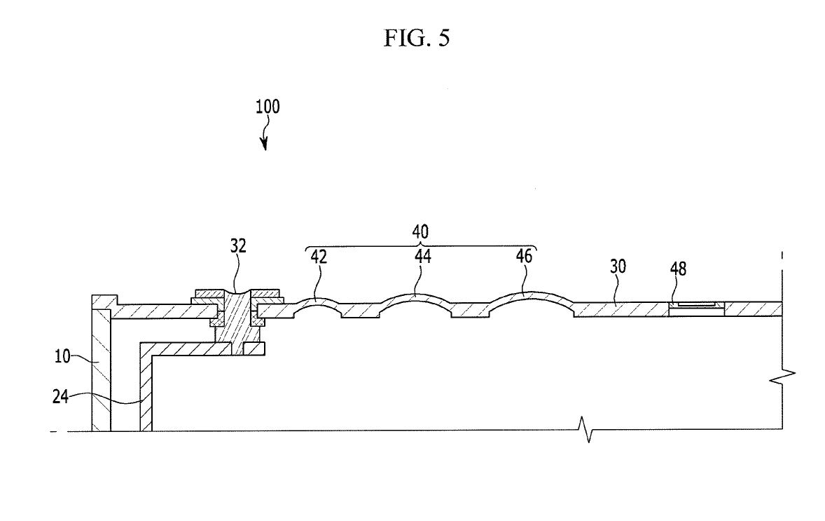

FIG. 5 illustrates a partial cross-sectional view of operation of a third membrane of the rechargeable battery in FIG. 2.

FIG. 5 shows a state in which the third membrane 46 is flipped, i.e., the third membrane 46 is convex with respect to the outside of the case 10. A user may understand that the internal pressure of the rechargeable battery 100 is increased and is being maintained higher than the cases, e.g., the situations or instances, of the first and second membranes 42 and 44 the manufacturer sets.

As described before, if the heat generated in the rechargeable battery 100 decomposes the electrolyte to generate gas, abnormally increasing the internal pressure, the rechargeable battery 100 may be at the end of its life. The third membrane 46 flipped may notify the user of the preset internal pressure state of the rechargeable battery 100 and a replacement time of the rechargeable battery 100.

For example, upon noticing that all of the membranes up to the third membrane 46 are convex upward over the case 10 of the rechargeable battery 100, the user may understand that the cycle-life of the rechargeable battery 100 may be finished, to replace the rechargeable battery 100 at, for example, a service center, for continuing smooth operation of the apparatus.

By way of summation and review, a high power rechargeable battery may include a high energy density non-aqueous electrolyte, and the high power rechargeable battery may have a large capacity rechargeable battery with a plurality of rechargeable batteries connected in series for use in driving a motor of an apparatus which may require high power, for example, an electric vehicle.

One large capacity rechargeable battery may have a plurality of rechargeable batteries connected in series, and the rechargeable battery may have a cylindrical or prismatic shape.

The rechargeable battery may have a structure in which terminals connected to an electrode assembly including a positive electrode and a negative electrode positioned on opposite sides of a separator are projected outside of the electrode assembly.

If internal pressure of the rechargeable battery rises abnormally due to gas generated as the electrolyte decomposes by heat generated inside of the rechargeable battery, the rechargeable battery may explode. In order to prevent such explosion of the rechargeable battery, it may be necessary to stop operation of the rechargeable battery if the internal pressure of the rechargeable battery rises to more than a preset pressure. Consequently, a scheme may be required in which whether the pressure in the rechargeable battery rises abnormally or not may be detected in advance and action may be taken accordingly, and smooth operation of the apparatus may be continued by predicting a lifetime of the rechargeable battery to determine a replacement time of the rechargeable battery.

Provided is a rechargeable battery that may enable determination of internal pressure of the rechargeable battery from outside of the rechargeable battery. Embodiments relate to a rechargeable battery having a membrane. Provided is a rechargeable battery that may have a membrane provided to a cap plate for determining internal pressure of the rechargeable battery from outside of the rechargeable battery.

Since the rechargeable battery may have the membranes mounted to the cap plate between the first terminal and the second terminal for causing flipping of the membranes as a reaction to gas generated in the rechargeable battery, the flipping may be determined from outside of the rechargeable battery with the naked eye.

Since the first, second, and third membranes may have different surface areas from one another, a volume of the rechargeable battery may be increased by as much as, e.g., a volume equal to, displacement of respective membranes that are flipped if the membranes flip in response to the internal pressure of the rechargeable battery, the internal pressure of the rechargeable battery may drop, and secure charging and discharging of the rechargeable battery may be expected.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery, comprising:
an electrode assembly including a first electrode and a second electrode;
a case having an open side, the electrode assembly housed in the case;
a cap assembly having a cap plate to tightly close the open side of the case, a first terminal connected to the first electrode electrically, and a second terminal electrically connected to the second electrode; and
at least one membrane mounted to the cap plate between the first terminal and the second terminal.

2. The rechargeable battery as claimed in claim 1, wherein the at least one membrane is concave or convex.

3. The rechargeable battery as claimed in claim 1, including a plurality of membranes, wherein each of the plurality of membranes has a different threshold value for causing sequential flipping of the plurality of membranes if an internal pressure of the case rises due to gas generated in the case.

4. The rechargeable battery as claimed in claim 3, wherein each of the plurality of membranes has a different surface area.

5. The rechargeable battery as claimed in claim 3, wherein each of the plurality of membranes has a different thickness.

6. The rechargeable battery as claimed in claim 3, wherein each of the plurality of membranes is formed of an elastic material to have elastic force.

7. The rechargeable battery as claimed in claim 3, wherein the cap plate and the plurality of membranes are connected by welding.
